(19) United States
(12) Patent Application Publication
(10) Pub. No.: US 2019/0302889 A1
(43) Pub. Date: Oct. 3, 2019

(54) Static Pattern Electrostatic Haptic Electrodes

(71) Applicant: Apple Inc., Cupertino, CA (US)

(72) Inventor: Mark A. Salada, Sunnyvale, CA (US)

(21) Appl. No.: 16/286,433

(22) Filed: Feb. 26, 2019

Related U.S. Application Data
(60) Provisional application No. 62/650,691, filed on Mar. 30, 2018.

(51) Int. Cl. G06F 3/01; G06F 3/044; G06F 3/041

(52) U.S. Cl. CPC G06F 3/016; G06F 3/0416; G06F 3/044

(57) ABSTRACT

A virtual keyboard device includes a surface, a static pattern electrostatic haptic electrode disposed on an area of the surface, the static pattern electrostatic haptic electrode defining voids on the area of the surface between contiguous portions of the static pattern electrostatic haptic electrode, insulating material disposed on the static pattern electrostatic haptic electrode, and a controller operable to apply a voltage to the static pattern electrostatic haptic electrode. Application of the voltage to the static pattern electrostatic haptic electrode may produce a variable friction between a conductive object and the insulating material as the conductive object moves across the insulating material. In some implementations, the surface may be part of a display device that is configured to display a virtual key of a virtual keyboard in the area.

### CROSS-REFERENCE TO RELATED APPLICATION

This application claims the benefit under 35 U.S.C. § 119(e) of U.S. Provisional Patent Application No. 62/650,691, filed Mar. 30, 2018, entitled “Static Pattern Electrostatic Haptic Electrodes,” the contents of which are incorporated by reference as if fully disclosed herein.

### FIELD

The described embodiments relate generally to haptics using electrostatics. More particularly, the present embodiments relate to haptics that use static pattern electrostatic haptic electrodes and/or multiple different voltages to provide a variety of haptic output.

### BACKGROUND

Electronic devices may include a variety of input and/or output devices for interacting with users. For example, electronic devices may provide visual output via one or more displays or other indicators, audio output via one or more speakers, haptic output via one or more vibration actuators or other devices, and so on. Electronic devices may also receive input via one or more touch screens or other sensors, physical or virtual keyboards, track pads, buttons, force sensors, and so on.

In some implementations, electronic devices may include components that both receive input and provide output. For example, a vibration actuator may be configured to provide haptic feedback when an input is received via a virtual keyboard presented on a touch display. Feedback for such components may enhance user experience as this may simulate physical responses users have come to expect from traditionally three-dimensional and mechanical apparatuses that have been more contemporaneously implemented using non-traditional mechanisms, such as flat surfaces that do not use moving parts.

Some electronic devices may provide feedback or other output using electrostatics. Electrostatics may use an electrical field to attract and/or repel conductive objects, such as a user's finger. Changing the normal force between a surface and a conductive object directly affects the friction between the two, and the resulting forces may be perceived as texture when the object moves.

### SUMMARY

The present disclosure relates to haptics that use one or more static pattern electrostatic haptic electrodes driven by one or more voltages to provide a variety of haptic output. A static pattern electrostatic haptic electrode may be disposed on a surface, such as a surface area of a display configured to display a virtual key of a virtual keyboard. An insulator covers the static pattern electrostatic haptic electrode. The static pattern electrostatic haptic electrode may include one or more portions of conductive material that define one or more closed spaces, voids, gaps, and so on within the conductive material. Voltage may be applied to the conductive material to create an electrostatic field that interacts with a user's finger or other conductive object that moves over the insulator. This may change the effective friction at various points during the movement, providing a variety of different electrostatic haptic outputs.

In various embodiments, a haptic display may include a display device that is operable to display a virtual key within a virtual key area of the display device, a static pattern electrostatic haptic electrode coupled to the display device in the virtual key area, an insulator covering the static pattern electrostatic haptic electrode, and a controller operable to provide a voltage to the static pattern electrostatic haptic electrode. The static pattern electrostatic haptic electrode may include conductive material and at least one void defined within the conductive material.

In some examples, the haptic display may further include additional static pattern electrostatic haptic electrodes. In various cases of such examples, the static pattern electrostatic haptic electrode and the additional static pattern electrostatic haptic electrodes are arranged in a keyboard configuration, the display device is operable to display a virtual keyboard corresponding to the keyboard configuration, and the controller is operable to provide the voltage to the static pattern electrostatic haptic electrode and voltages to the additional static pattern electrostatic haptic electrodes when the display device displays the virtual keyboard.

In numerous examples, the conductive material comprises at least two separate portions and the controller is operable to provide at least two different voltages to the two separate portions. In some examples, the static pattern electrostatic haptic electrode includes less of the conductive material at a center of the virtual key area than at an edge of the virtual key area. In various examples, the static pattern electrostatic haptic electrode includes a first section with a first surface area percentage occupied by the conductive material and a second section with a second surface area percentage occupied by the conductive material that is less than the first surface area percentage.

In some examples, the controller provides the voltage to the static pattern electrostatic haptic electrode when the display device is displaying the virtual key within the virtual key area of the display device. In various examples, the display device is operable to display the virtual key within the virtual key area of the display device or an additional virtual key within an additional virtual key area of the display device depending on an orientation of the haptic display, the haptic display includes an additional static pattern electrostatic haptic electrode coupled to the display device in the additional virtual key area, the controller provides the voltage to the static pattern electrostatic haptic electrode when the display device is displaying the virtual key within the virtual key area of the display device, and the controller provides the voltage to the additional static pattern electrostatic haptic electrode when the display device is displaying the additional virtual key within the additional virtual key area of the display device. In numerous examples, the controller provides the voltage to the static pattern electrostatic haptic electrode via an inductive power transmitter.

In some embodiments, a virtual keyboard device includes a surface, conductive material disposed on an area of the surface, voids surrounded by portions of the conductive material within the area of the surface such that a surface area percentage occupied by the conductive material is different in different sections of the area of the surface, insulating material disposed on the conductive material, and a controller. The controller is operable to provide a voltage to the conductive material.

In various examples, the conductive material includes at least a first portion of the conductive material that surrounds a second portion of the conductive material. In some examples, the controller is operable to provide different voltages to the first portion of the conductive material and the second portion of the conductive material.

In numerous examples, the haptic output device further includes touch sensing circuitry the controller is operable to use to determine a touch of a conductive object to the surface. In some cases of such examples, the controller is operable to provide the voltage to the conductive material and use the touch sensing circuitry to determine the touch of the conductive object to the surface at different times. In various cases of such examples, the conductive material is part of the touch sensing circuitry.

In numerous embodiments, a virtual keyboard device includes a surface; a static pattern electrostatic haptic electrode disposed on an area of the surface, the static pattern electrostatic haptic electrode defining voids on the area of the surface between contiguous portions of the static pattern electrostatic haptic electrode; insulating material disposed on the static pattern electrostatic haptic electrode; and a controller operable to apply a voltage to the static pattern electrostatic haptic electrode. Application of the voltage to the static pattern electrostatic haptic electrode produces a variable friction between a conductive object and the insulating material as the conductive object moves across the insulating material. In various examples, the surface is a keyboard key.

In some examples, the friction between the conductive object and the insulating material decreases as the conductive object moves across the insulating material towards a center of the static pattern electrostatic haptic electrode. In various examples, the friction between the conductive object and the insulating material increases as the conductive object moves across the insulating material towards a center of the static pattern electrostatic haptic electrode.

In numerous examples, the controller is operable to apply the voltage to the static pattern electrostatic haptic electrode to simulate a texture gradient change as the conductive object moves across the insulating material. In various examples, the surface is planar and the controller is operable to apply the voltage to the static pattern electrostatic haptic electrode to simulate that the surface is curved.

### BRIEF DESCRIPTION OF THE DRAWINGS

The disclosure will be readily understood by the following detailed description in conjunction with the accompanying drawings, wherein like reference numerals designate like structural elements.

FIG. 1 depicts an example electronic device with a haptic display.

FIG. 2A depicts a side view of an example electrostatic haptic output device that may be used in the haptic display of FIG. 1.

FIG. 2B depicts a top view of an example electrostatic haptic electrode that may be used in the example electrostatic haptic output device of FIG. 2A.

FIG. 2C depicts an example elaboration of the example electrostatic haptic output device of FIG. 2A.

FIG. 3 depicts an example of a static pattern electrostatic haptic electrode including conductive material and voids defined within, which static pattern electrostatic haptic electrode may be used in the example electrostatic haptic output device of FIG. 2A instead of and/or in addition to the example electrostatic haptic electrode of FIG. 2B.

FIG. 4A depicts a first alternative example of the static pattern electrostatic haptic electrode of FIG. 3.

FIG. 4B depicts a second alternative example of the static pattern electrostatic haptic electrode of FIG. 3.

FIG. 4C depicts a third alternative example of the static pattern electrostatic haptic electrode of FIG. 3.

FIG. 4D depicts a fourth alternative example of the static pattern electrostatic haptic electrode of FIG. 3.

FIG. 4E depicts a fifth alternative example of the static pattern electrostatic haptic electrode of FIG. 3.

FIG. 4F depicts a sixth alternative example of the static pattern electrostatic haptic electrode of FIG. 3.

FIG. 4G depicts a seventh alternative example of the static pattern electrostatic haptic electrode of FIG. 3.

FIG. 4H depicts an eighth alternative example of the static pattern electrostatic haptic electrode of FIG. 3.

FIG. 4I depicts a ninth alternative example of the static pattern electrostatic haptic electrode of FIG. 3.

FIG. 4J depicts a tenth alternative example of the static pattern electrostatic haptic electrode of FIG. 3.

FIG. 4K depicts an eleventh alternative example of the static pattern electrostatic haptic electrode of FIG. 3.

FIG. 5A depicts an example multi-portion static pattern electrostatic haptic electrode that may be used in the example electrostatic haptic output device of FIG. 2A instead of and/or in addition to the example electrostatic haptic electrode of FIG. 2B.

FIG. 5B depicts a first alternative example of the multi-portion static pattern electrostatic haptic electrode of FIG. 5A.

FIG. 5C depicts a second alternative example of the multi-portion static pattern electrostatic haptic electrode of FIG. 5A.

FIG. 5D depicts a third alternative example of the multi-portion static pattern electrostatic haptic electrode of FIG. 5A.

FIG. 5E depicts a fourth alternative example of the multi-portion static pattern electrostatic haptic electrode of FIG. 5A.

FIG. 6 depicts an arrangement of static pattern electrostatic haptic electrodes that may be disposed on a surface where a virtual keyboard may be displayed.

FIG. 7 depicts an example electronic device with a haptic display that includes multiple arrangements of static pattern electrostatic haptic electrodes disposed where one or more virtual keyboards may be displayed.

FIG. 8 depicts relationships between components of an electronic device that is operable to provide haptic output via an electrostatic haptic display or other electrostatic haptic output device.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, and computer program products that embody various elements of the present disclosure. However, it should be understood that the described disclosure may be practiced in a variety of forms in addition to those described herein.

The following disclosure relates to electronic devices that use static pattern electrostatic haptic electrodes to provide a variety of different haptic feedback. An static pattern electrostatic haptic electrode may include conductive material that defines one or more voids within the conductive material and is disposed on an area of a surface under an insulator. Differing amounts of conductive material in an area, or the presence of voids in the conductive material, may cause electrostatic fields of differing strengths to interact with conductive objects, such as a user's finger, moving across the insulator. This may attract or repel the conductive object by different amounts, resulting in different frictions between the conductive object and the insulator that may be perceptible as different textures or relief patterns. In this way, a static pattern electrostatic haptic electrode may be used to provide a variety of different haptic feedback depending on the varying surface area percentage (varying percentages of conductive material or voids in different areas such as 100% for a surface area totally covered by conductive material or 0% for a surface area where conductive material is totally absent) or pattern of the conductive material.

A static pattern electrostatic haptic electrode may be an electrostatic haptic electrode that includes one or more different portions of conductive material separated by one or more spaces, gaps, voids, and so on defined within the conductive material. This configuration differentiates the static pattern electrostatic haptic electrode from a solid electrode. This configuration differentiates the static pattern electrostatic haptic electrode from dynamic pattern electrostatic haptic electrodes, which are arrangements of individually controllable haptic electrode elements that can be dynamically configured by controlling individual elements to form different arrangements.

Further, in some implementations, the conductive material may include separate portions that may be provided the same or different voltages. As the voltage provided to the conductive material affects the strength of the electrostatic field, separate conductive material portions with different voltages may increase the variety of haptic feedback that may be provided by a set of static pattern electrostatic haptic electrodes.

For example, a static pattern electrostatic haptic electrode may be disposed on a planar haptic display where a virtual key of a virtual keyboard may be displayed. The static pattern electrostatic haptic electrode may include conductive material and voids within the conductive material such that the conductive material is densest at the edges of the virtual key (has a highest percentage of area occupied by conductive material as opposed to voids) and decreases towards a center of the virtual key (has decreasing percentages of area occupied by conductive material as opposed to voids), where conductive material may be absent. This may allow the static pattern electrostatic haptic electrode to simulate a texture gradient or other texture change effect as a user's finger moves from an edge of the virtual key towards the center, simulating a concave depression in the surface of the virtual key despite the planar nature of the haptic display. Other electrostatic effects are possible and contemplated.

When static pattern electrostatic haptic electrodes are used with a virtual key of a virtual keyboard or similar component, perceived textures and/or perceived shape differences related to different effective frictions may allow for user interactions that are more similar to more traditional three-dimensional and mechanical input structures. For example, this may allow users to find virtual keys and/or orient themselves on virtual keys during the small finger/hand motions users normally perform when typing on more traditional three-dimensional and mechanical keyboards. This may result in an improved user experience for virtual keyboards or other buttons or components.

Further, as the orientations and locations where virtual keyboards and/or other components will be displayed may be known beforehand, the configuration of the static pattern electrostatic haptic electrodes may be static and designed to simulate textures, texture gradients, and shapes related to movement across virtual keys in particular directions. This may allow for creation of a wide variety of electrostatic haptic output.

Thus, in some implementations, a haptic display may include a display device that is operable to display a virtual key within a virtual key area of the display device. A static pattern electrostatic haptic electrode may be coupled to the display device in the virtual key area. The static pattern electrostatic haptic electrode may include conductive material and at least one void defined within the conductive material. An insulator covers the static pattern electrostatic haptic electrode. A controller may be operable to provide a voltage to the static pattern electrostatic haptic electrode.

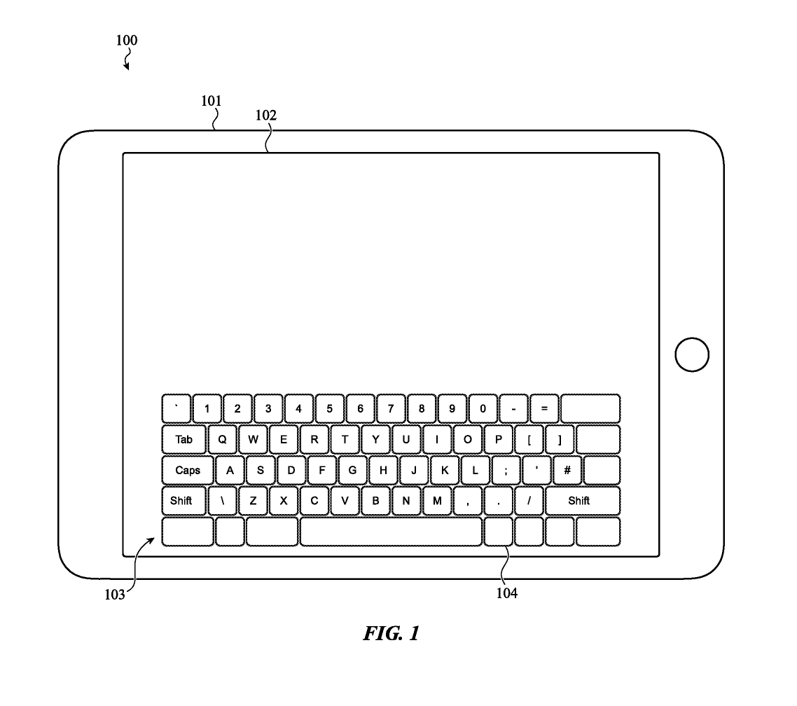

These and other embodiments are discussed below with reference to FIGS. 1-8. However, those skilled in the art will readily appreciate that the detailed description given herein with respect to these Figures is for explanatory purposes only and should not be construed as limiting.

FIG. 1 depicts an example electronic device 100 that includes a housing 101 and a haptic display 102. The electronic device 100 may be operable to provide electrostatic haptic output via the haptic display 102. For example, the haptic display 102 may be a touch display and the electronic device 100 may be operable to display a virtual keyboard 103 with one or more virtual keys 104 that a user may touch (with or without applied force). The haptic display 102 may include one or more haptic electrodes disposed in areas where the virtual keys 104 are displayed. The haptic electrodes bay be used to provide electrostatic haptic output for the virtual keyboard 103.

In some implementations, the electrostatic haptic electrodes may be solid electrodes that cover the entire virtual key area. This may allow the haptic display 102 to provide a single electrostatic haptic output for the virtual key 104 by providing a voltage to the electrostatic haptic electrode. The single electrostatic haptic output may be varied by varying the voltage at different times. In other implementations, the haptic electrodes may be static pattern electrostatic haptic electrodes that include various configurations of conductive material and spaces, gaps, voids, or the like. This may allow the haptic display 102 to provide a variety of different electrostatic haptic outputs for the virtual key 104 simultaneously. In still further implementations, the static pattern electrostatic haptic electrodes may include separate portions of conductive material that the haptic display 102 may provide with different voltages at the same time. This may allow the haptic display 102 to provide even more different electrostatic haptic outputs for the virtual key 104 at one or more different times. These and other aspects of the present disclosure will be discussed in more detail below.

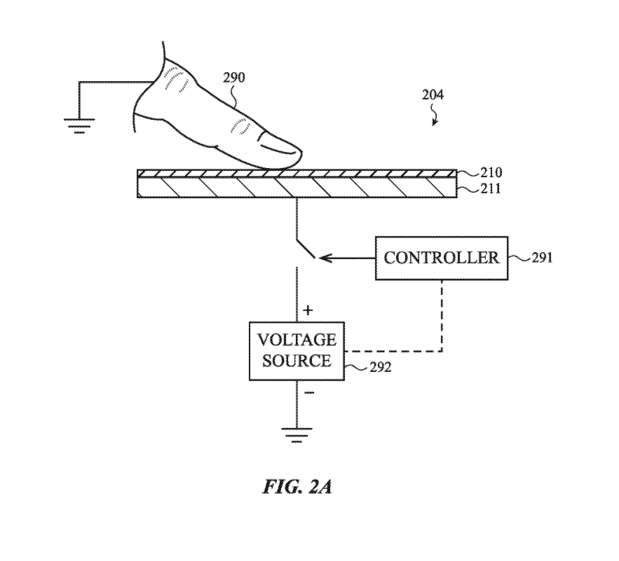

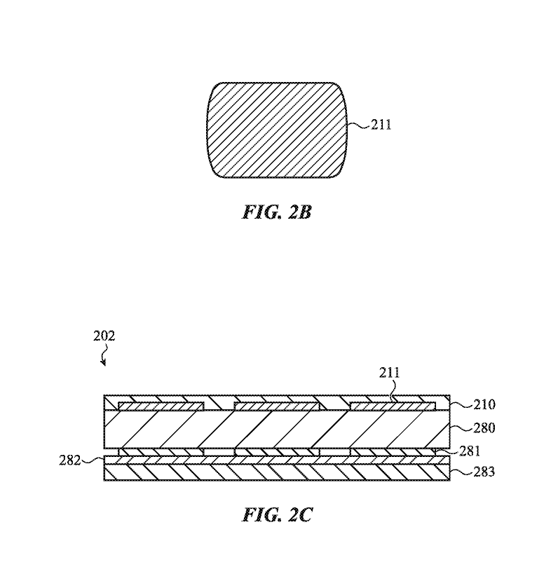

FIG. 2A depicts a side view of an example electrostatic haptic output device 204 that may be used in the haptic display 102 of FIG. 1. In some implementations, the electrostatic haptic output device 204 may be included in a virtual keyboard device. The electrostatic haptic output device 204 may correspond to the area of the virtual key 104 on the haptic display 102 of FIG. 1. A layer of insulator 210 (such as a layer of polymer or another non-conductive material that is approximately 1-3 microns thick) may be disposed on an electrostatic haptic electrode 211 (which may include any conductive material, such as piezoelectric material, indium tin oxide, and so on). A voltage may be provided to the electrostatic haptic electrode 211. For example, the voltage may be provided by a voltage source 292 under the direction of a controller 291. The controller 291 may operate the voltage source 292 and/or one or more switches or other components to apply voltage, remove voltage, adjust voltage, and so on. The voltage provided to the electrostatic haptic electrode 211 may create an electrical field that influences a conductive object touching the insulator 210, such as a user's finger 290. This may cause the user's finger 290 to be attracted to the electrostatic haptic electrode 211. Though this may not be perceptible to a user when their finger 290 is stationary on the insulator 210, the attraction may increase the normal force, and thus the effective friction, when the user moves their finger 290 across the surface of the insulator 210. This allows for dynamic control of the lateral forces on the finger 290 and may be perceived as texture.

The voltage may be provided using a carrier signal, such as a simple sine wave at a constant frequency. The signal amplitude may be modulated to create texture effects. This may be referred to as “envelope” rendering. This technique may be very effective at homogenous texture rendering.

FIG. 2B depicts a top view of an example electrostatic haptic electrode 211 that may be used in the example electrostatic haptic output device 204 of FIG. 2A. In this example, the electrostatic haptic electrode 211 may include conductive material distributed uniformly throughout the area corresponding to the surface of the insulator 210. Thus, the surface area percentage occupied by the conductive material, or the amount of conductive material any portion of the area covered of the electrostatic haptic electrode 211, is 100%.

However, in other implementations, the electrostatic haptic electrode 211 may be a static pattern electrostatic haptic electrode. A static pattern electrostatic haptic electrode may be an electrostatic haptic electrode that includes one or more different portions of conductive material separated by one or more spaces, gaps, voids, and so on defined within the conductive material. This configuration differentiates the static pattern electrostatic haptic electrode from a solid electrode such as the electrostatic haptic electrode 211 of FIG. 2B. This configuration differentiates the static pattern electrostatic haptic electrode from dynamic pattern electrostatic haptic electrodes, which are arrangements of individually controllable haptic electrode elements that can be dynamically configured by controlling individual elements to form different arrangements. The configuration of the static pattern electrostatic haptic electrode may allow the static pattern electrostatic haptic electrode to attract and/or repel conductive objects differently at different areas of the insulator 210 as different densities of conductive material (percentage of an area occupied by conductive material as opposed to voids in the conductive material) may be disposed in the different areas. This will be discussed in further detail below.

FIG. 2C depicts an example elaboration of the example electrostatic haptic output device 204 of FIG. 2A. This elaboration may be a compound electrostatic haptic output device 202, which may correspond to a portion of the haptic display 102 of FIG. 1. The compound electrostatic haptic output device 202 may include multiple static pattern electrostatic haptic electrodes 211 that may each be positioned in virtual key 104 areas. The multiple static pattern electrostatic haptic electrodes 211 may be positioned on a substrate 280, such as a cover glass, and the insulator 210 may be positioned on the multiple static pattern electrostatic haptic electrodes 211.

Inductive transmitter electrodes 281 may be positioned on a surface of the substrate 280 opposing the multiple static pattern electrostatic haptic electrodes 211. The inductive transmitter electrodes 281 may be able to individually provide voltages to the respective static pattern electrostatic haptic electrodes 211 by inductive power transmission. This may prevent a conductive object from directly connecting to a power source that supplies the voltage should the insulator 210 be removed to allow the conductive object to contact the static pattern electrostatic haptic electrodes 211. However, it is understood that this is an example. In other implementations, conductive material such as wires, traces, or other connectors may be positioned to directly electrically couple the static pattern electrostatic haptic electrodes 211 to one or more voltage sources. For example, conductive material such as wires, traces, or other connectors directly electrically couple the static pattern electrostatic haptic electrodes 211 to one or more voltage sources through a physically connected switched coupling path.

The compound electrostatic haptic output device 202 may also include touch sensing circuitry 282, such as a capacitive touch sensing layer. In some implementations, providing voltage to the static pattern electrostatic haptic electrodes 211 may interfere with touch sensing. As such, in such implementations, the compound electrostatic haptic output device 202 may time multiplex electrostatic haptic output and touch sensing, or provide voltage to the static pattern electrostatic haptic electrodes 211 and sense touch using the touch sensing circuitry 282 at different times. In other implementations, the compound electrostatic haptic output device 202 may use the static pattern electrostatic haptic electrodes 211 as part of the touch sensing circuitry 282, such as by sensing capacitance between the static pattern electrostatic haptic electrodes 211 and other conductors.

The compound electrostatic haptic output device 202 may also include display circuitry 283. As shown, components such as the touch sensing circuitry 282 and the static pattern electrostatic haptic electrodes 211 may be positioned over the display circuitry 283 (e.g., between the display circuitry 283 and the insulator 210). As such, these components may be formed of transparent or translucent materials such as indium tin oxide. However, it is understood that this is an example and that in other implementations the described components may be arranged in different manners without departing from the scope of the present disclosure.

In various implementations, s voltage may be provided to the static pattern electrostatic haptic electrodes 211 as an alternating current carrier signal that uses the full oscillation of the alternating current signal to simulate the full possible feeling of textural sensation. However, different factors may influence how much a particular electrostatic field influences a particular user's finger 290. Such factors include how wet or dry the finger 290 or the surface is, calluses on the finger 290, and so on. In various implementations, electrical properties of the user's finger 290 may be sensed or otherwise determined and the current in the user's finger 290 may be explicitly controlled when providing the voltage using closed loop detection. This may result in the electrostatic field more uniformly affecting different users' fingers 290 despite the varying factors that may influence this, resulting in more uniform electrostatic haptic output to different users.

Referring again to FIG. 2B, the solid conductive material of the electrostatic haptic electrode 211 extending throughout the area covered by the insulator 210 may be effective at rendering a single texture for the insulator 210 surface. However, this configuration may not be able to provide electrostatic haptic outputs with a variety of features since any attraction/repulsion of a conductive object would be the same across the entirety of the insulator 210 surface.

FIG. 3 depicts an example of a static pattern electrostatic haptic electrode 311 that may be disposed in an area 304 of an electrostatic haptic output device, such as instead of and/or in addition to the example electrostatic haptic electrode 211 of FIG. 2B in the electrostatic haptic output device 204 of FIG. 2A or in the haptic display 102 of FIG. 1. The static pattern electrostatic haptic electrode 311 includes conductive material and voids 312, gaps, spaces, and so on that are defined within the conductive material.

Due to the configuration of the conductive material and the voids 312, the surface coverage of the conductive material (the surface area percentage occupied by the conductive material or amount of conductive material at a particular location) in a given section (such as sections 313, 314, 315, 316) of a portion of the static pattern electrostatic haptic electrode 311 may be different than in other sections. This may allow differences in attraction and thus difference in effective friction as a conductive object, such as a user's finger, moves across an insulator disposed over the static pattern electrostatic haptic electrode 311. Effective friction may be greatest for sections where surface area percentage occupied by the conductive material is greatest and least where surface area percentage occupied by the conductive material is least. This may allow for texture gradients across the insulator. This may also allow the static pattern electrostatic haptic electrode 311 to be used to provide a greater variety of electrostatic haptic output at a single time than the electrostatic haptic electrode 211 of FIG. 2B.

For example, the static pattern electrostatic haptic electrode 311 includes no voids 312 in the conductive material in section 313. As such, the surface area percentage occupied by the conductive material or amount of the conductive material in section 313 may be 100%. However, the static pattern electrostatic haptic electrode 311 includes voids 312 formed as small circles in the conductive material in section 314 and larger voids 312 formed as larger circles in the conductive material in section 315. Thus, the surface area percentage occupied by the conductive material may be less in section 314 than in section 313, and less in section 315 than in 314. Further, the static pattern electrostatic haptic electrode 311 includes a still larger void 312 in the center of the static pattern electrostatic haptic electrode 311 in section 316 such that no conductive material is present. Thus, the surface area percentage occupied by the conductive material in section 316 is still further less than in section 315, or zero percent.

The differing densities of conductive material in sections 313, 314, 315, and 316 may allow for different effective frictions in corresponding different areas of an insulator disposed over the static pattern electrostatic haptic electrode 311 as the voids 312 are not provided any voltage. Thus, a conductive object, such as a user's finger, that moves across the insulator in an area corresponding to section 313 moves over more material where a voltage is provided than when moving over the insulator in an area corresponding to section 316.

Different effective frictions at different areas may also allow different portions of a user's finger to move differently as the different portions of the user's finger may move across areas with different effective frictions at the same time. This may stretch the surface of the skin on the user's finger, or tangentially stretch the user's skin. Tactile nerves may register tangential skin stretch more perceptibly to a user than movements that compress the user's skin inward. Thus, the electrostatic haptic output may be more noticeable to a user than other kinds of haptic output that do not tangentially stretch the user's skin.

The human brain generally accords more weight to information from tactile nerves on fingertips than to tactile nerves further up the arms and hands. Thus, by simulating textures by affecting tactile nerves in the fingertips as described above, information from other tactile nerves may be overridden such that a fingertip moving across such a surface perceives textures or shapes that are not there. For example, the lessening surface area percentage occupied by the conductive material in the static pattern electrostatic haptic electrode 311 from section 313 to section 316 may result in a texture gradient effect from an edge of the static pattern electrostatic haptic electrode 311 to a center of the static pattern electrostatic haptic electrode 311 (or from an edge to a center of a virtual key area such as the virtual key 104 of FIG. 1 that is displayed at a location where the static pattern electrostatic haptic electrode 311 is disposed). This may be perceived by a human user as a concave depression even if the insulator surface is actually planar or flat.

Although the static pattern electrostatic haptic electrode 311 is illustrated and described as having a lessening surface area percentage occupied by the conductive material from section 313 to section 316, it is understood that this is an example. In various implementations, the surface area percentage occupied by the conductive material may instead increase from an edge towards a center, increase and decrease multiple times from the edge to the center, or vary in other ways. Various configurations are possible and contemplated without departing from the scope of the present disclosure.

Further, although the static pattern electrostatic haptic electrode 311 is illustrated and described as symmetrical, in is understood that this is an example. In various implementations, symmetrical or asymmetrical configurations may be used without departing from the scope of the present disclosure.

When the static pattern electrostatic haptic electrode 311 is used with a virtual key of a virtual keyboard or similar component, such as the virtual key 104 of the virtual keyboard 103 of FIG. 1, these perceived texture and/or perceived shape differences related to the different effective frictions may allow for user interactions that are more similar to more traditional three-dimensional and mechanical input structures. For example, this may allow users to find virtual keys and/or orient themselves on virtual keys during the small finger/hand motions users normally perform when typing on more traditional three-dimensional and mechanical keyboards. This may result in an improved user experience for virtual keyboards or other buttons or components.

Further, as the orientations and locations where virtual keyboards and/or other components will be displayed may be known beforehand, the configuration of the static pattern electrostatic haptic electrode 311 may be static and designed to simulate textures, texture gradients, and shapes related to movement across virtual keys in particular directions. This may allow for creation of a wide variety of electrostatic haptic output.

Thus, in some implementations, a haptic display may include a display device that is operable to display a virtual key within a virtual key area of the display device. A static pattern electrostatic haptic electrode may be coupled to the display device in the virtual key area. The static pattern electrostatic haptic electrode may include conductive material and at least one void defined within the conductive material. An insulator covers the static pattern electrostatic haptic electrode. A controller may be operable to provide a voltage to the static pattern electrostatic haptic electrode.

In various implementations, an electrostatic haptic output device includes a surface, conductive material disposed on an area of the surface, gaps surrounded by portions of the conductive material within the area of the surface such that a surface area percentage occupied by the conductive material is different in different sections of the area of the surface, insulating material disposed on the conductive material and a controller operable to provide a voltage to the conductive material.

In numerous implementations, a virtual keyboard device includes a surface; a static pattern electrostatic haptic electrode disposed on an area of the surface, the static pattern electrostatic haptic electrode defining voids on the area of the surface between contiguous portions of the static pattern electrostatic haptic electrode; insulating material disposed on the static pattern electrostatic haptic electrode; and a controller operable to apply a voltage to the static pattern electrostatic haptic electrode. Application of the voltage to the static pattern electrostatic haptic electrode produces a variable friction between a conductive object and the insulating material as the conductive object moves across the insulating material.

Although FIG. 3 illustrates and describes a particular configuration of conductive material and voids 312 in the static pattern electrostatic haptic electrode 311, it is understood that this is an example. In various implementations, a wide variety of different static pattern electrostatic haptic electrodes may be used without departing from the scope of the present disclosure.

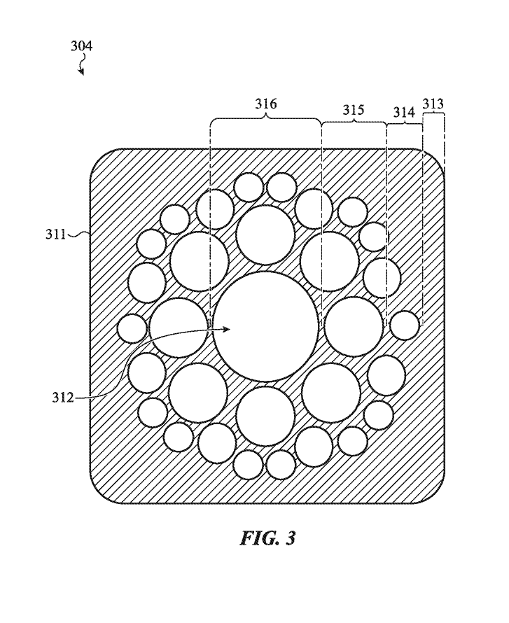

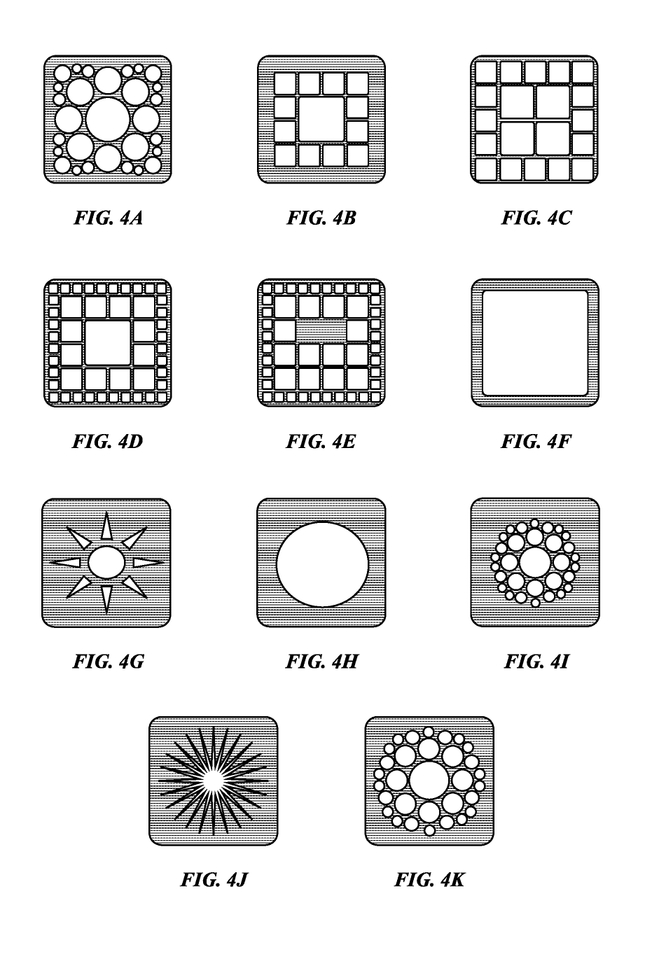

For example, the static pattern electrostatic haptic electrode 311 of FIG. 3 includes voids 312 in conductive material to have a wide edge of solid conductive material and uniform bands of circular voids 312 toward a center. By way of contrast, FIG. 4A depicts a first alternative example of the static pattern electrostatic haptic electrode 311 of FIG. 3 that includes a thinner edge of solid conductive material and intermixed circular voids of various diameters.

By way of further example, FIG. 4B depicts a second alternative example of the static pattern electrostatic haptic electrode 311 of FIG. 3, with uses square rectangular voids instead of circular voids. However, is it is understood that these are examples and that in various implementations, voids having any kind of geometric, non-geometric, regular, or irregular shape may be used without departing from the scope of the present disclosure. FIG. 4C depicts an example similar to that of FIG. 4B where the outer edge of solid conductive material is thinner and conductive material crosses the center. FIG. 4D depicts another example similar to that of FIG. 4B where arrangements of three different sizes of square voids are used instead of two.

FIG. 4E depicts an example where a rectangle of conductive material may be disposed in a center of various patterns of square voids. FIG. 4F depicts an example where the conductive material is a single band around the edges of a single large center square having rounded edges. Various configurations are possible and contemplated.

FIGS. 4G and 4J illustrate that various shapes such as sun or star shapes of various types may be used in some examples. FIG. 4H illustrates an example similar to that of FIG. 4F where a circle is used instead of a square. FIGS. 4I and 4K illustrate additional examples of arrangements of circles. Any pattern of conductive material to define spaces, gaps, voids, and so on may be used in various implementations without departing from the scope of the present disclosure.

The static pattern electrostatic haptic electrode 311 of FIG. 3 is illustrated and described as including a single continuous portion of conductive material that defines one or more voids 312 within and/or around the conductive material. The examples in FIGS. 4A-4K illustrate similar configurations. However, in some examples, static pattern electrostatic haptic electrodes may include separate portions of conductive material.

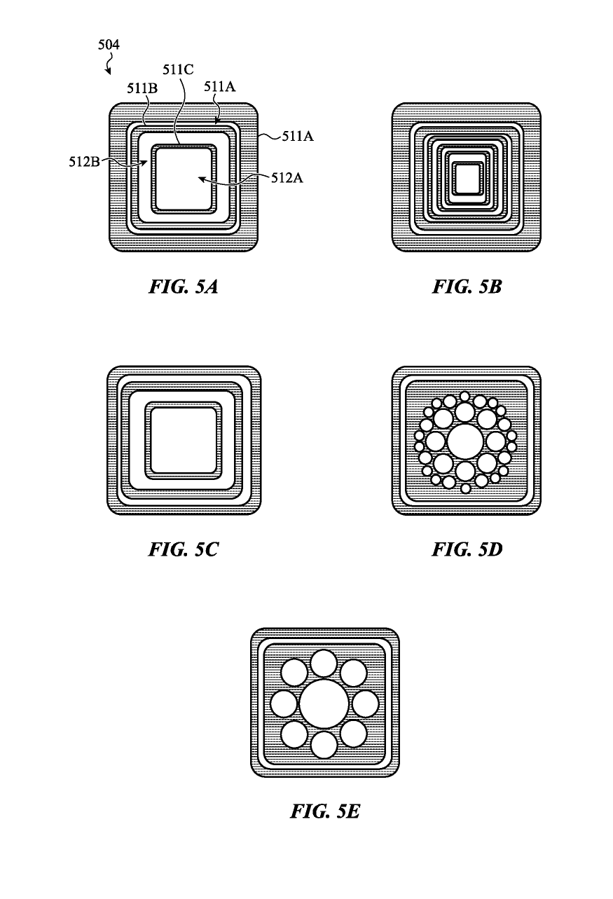

For example, FIG. 5A depicts an example multi-portion static pattern electrostatic haptic electrode 511A-C that may be disposed in an area 504 of an electrostatic haptic output device, such as instead of and/or in addition to the example electrostatic haptic electrode 211 of FIG. 2B in the electrostatic haptic output device 204 of FIG. 2A or in the haptic display 102 of FIG. 1. The multi-portion static pattern electrostatic haptic electrode 511A-C may define an array of voids 512A-C laid out in a Cartesian plane, a polar coordinate plane, and so on.

The multi-portion static pattern electrostatic haptic electrode 511A-C includes a first portion of conductive material of the multi-portion static pattern electrostatic haptic electrode 511A, a second portion of conductive material of the multi-portion static pattern electrostatic haptic electrode 511B, and a third portion of conductive material of the multi-portion static pattern electrostatic haptic electrode 511C. A first void 512A is positioned at the center. A second void 512B separates the second portion of conductive material of the multi-portion static pattern electrostatic haptic electrode 511B and the third portion of conductive material of the multi-portion static pattern electrostatic haptic electrode 511C. A third void 512C separates the first portion of conductive material of the multi-portion static pattern electrostatic haptic electrode 511A and the second portion of conductive material of the multi-portion static pattern electrostatic haptic electrode 511B. The second portion of conductive material of the multi-portion static pattern electrostatic haptic electrode 511B surrounds the third portion of conductive material of the multi-portion static pattern electrostatic haptic electrode 511C. The first portion of conductive material of the multi-portion static pattern electrostatic haptic electrode 511A surrounds the second portion of conductive material of the multi-portion static pattern electrostatic haptic electrode 511B.

As the different portions of conductive material are separate, different voltages may be provided to each. The ability to provide different voltages to different portions may further increase the variety of different electrostatic haptic output that can be provided. For example, in one implementation, a first voltage may be provided to the first portion of conductive material of the multi-portion static pattern electrostatic haptic electrode 511A, a second voltage may be provided to the second portion of conductive material of the multi-portion static pattern electrostatic haptic electrode 511B, and a third voltage may be provided to the third portion of conductive material of the multi-portion static pattern electrostatic haptic electrode 511C. In some examples, the first voltage may be 600 volts, the second voltage may be 400 volts, and the third voltage may be 200 volts. This may result in the electrostatic field attraction being strongest at the edge and diminishing towards the center even beyond what would be otherwise accomplished using the different densities of the conductive material in the different areas.

However, it is understood that this is an example. In various implementations, the same voltage may be applied to different portions. Various configurations are possible and contemplated without departing from the scope of the present disclosure.

Although FIG. 5A depicts a multi-portion static pattern electrostatic haptic electrode 511A-C having a particular configuration, it is understood that this is an example. Variously configured multi-portion static pattern electrostatic haptic electrodes may be used in various implementations without departing from the scope of the present disclosure.

For example, FIG. 5B depicts a first alternative example of a multi-portion static pattern electrostatic haptic electrode. Contrasted with the multi-portion static pattern electrostatic haptic electrode 511A-C of FIG. 5A, the multi-portion static pattern electrostatic haptic electrode of FIG. 5B includes additional rounded squares of conductive material disposed in the center. FIG. 5C depicts a second alternative example of the multi-portion static pattern electrostatic haptic electrode 511A-C of FIG. 5A that includes a thinner outer edge of conductive material. FIGS. 5D and 5E illustrate still further examples where multi-portion static pattern electrostatic haptic electrodes define circular spaces, gaps, voids, and so on in addition to rectangular and/or rounded rectangular ones. Various configurations are possible and contemplated without departing from the scope of the present disclosure.

For example, in some implementations, conductive material may be used to electrostatically convey information. For example, conductive material may be positioned at the center to convey information related to a particular virtual key or other component associated with a multi-portion static pattern electrostatic haptic electrode or other static pattern electrostatic haptic electrode. For example, conductive material may electrostatically convey braille or alphabetic letters related to a virtual key, bumps indicating one or more virtual keys in what is generally referred to on a keyboard as the “home row” (the keys on a keyboard where fingers are typically kept at rest, such as bumps on “F” and “J” keys indicating positions of groups of keys “A”, “S”, “D”, “F” and “J”, “K”, “L”, and “;”). In various implementations, a “home” key may have a different pattern of conductive material than other keys.

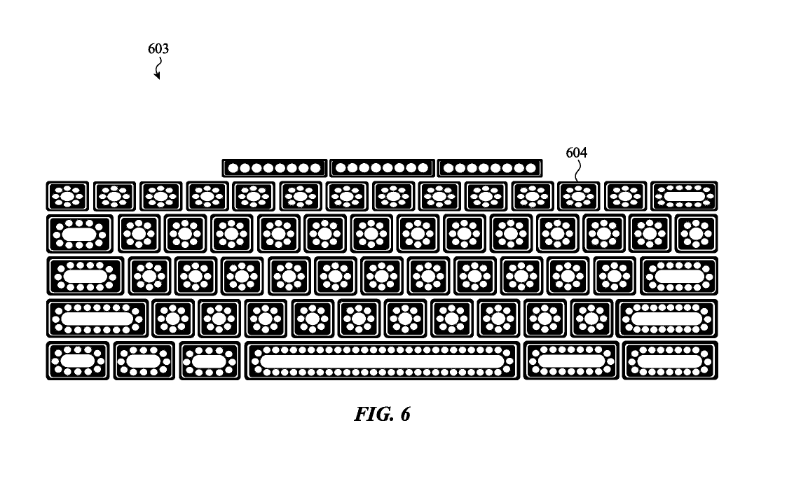

FIG. 6 depicts an arrangement 603 of static pattern electrostatic haptic electrodes 604 that may be disposed on a surface where a virtual keyboard may be displayed. Each static pattern electrostatic haptic electrode 604 may be disposed where a virtual key is configured to be displayed. As illustrated, differently configured static pattern electrostatic haptic electrodes 604 may be disposed in areas where different virtual keys may be displayed. In some cases, the differently configured static pattern electrostatic haptic electrodes 604 may correspond to different shapes of the different virtual keys. However, it is understood that this is an example and that any number of differently configured static pattern electrostatic haptic electrodes 604 may be used in a single implementation.

Further, although FIG. 6 depicts the arrangement 603 as including static pattern electrostatic haptic electrodes 604 for each virtual key of a virtual keyboard, it is understood that this is an example. In various implementations, static pattern electrostatic haptic electrodes 604 may be included for only a portion of the virtual keys of the virtual keyboard. For example, static pattern electrostatic haptic electrodes 604 may be included for home row virtual keys but not the other virtual keys of the virtual keyboard.

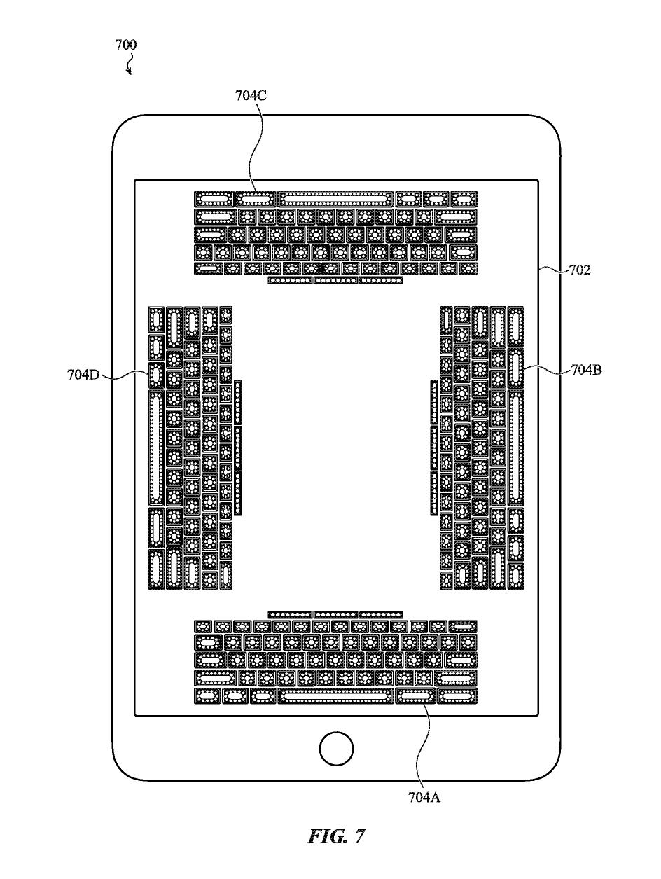

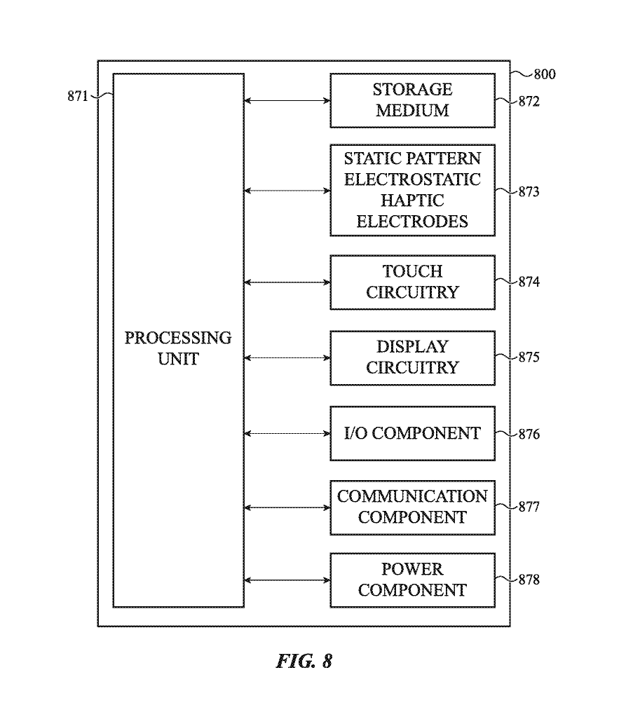

FIG. 7 depicts an example electronic device 700 with a haptic display 702 that includes multiple arrangements of static pattern electrostatic haptic electrodes 704A-704D disposed where one or more virtual keyboards may be displayed. In this example, the example electronic device 700 may be a tablet computing device that is operable to display a virtual keyboard in various places on the haptic display 702 depending on the orientation of the tablet computing device. In such implementations, re-orienting the tablet computing device may change where the virtual keyboard is displayed. Accordingly, the tablet computing device may activate (provide one or more voltages to) and/or deactivate (cease providing one or more voltages to) the static pattern electrostatic haptic electrodes 704A-704D depending on which corresponds to where the virtual keyboard is currently being displayed. If the tablet computing device is not currently displaying any virtual keyboard, the tablet computing device may be configured such that none of the static pattern electrostatic haptic electrodes 704A-704D are active. Various configurations are possible and contemplated without departing from the scope of the present disclosure.

Although FIGS. 1 and 7 both illustrate example electronic devices 100, 700 that are both tablet computing devices, it is understood that this is an example. In various implementations, the techniques discussed herein may be used in any kind of electronic device. Examples of such electronic devices include, but are not limited to, desktop computing devices, laptop computing devices, tablet computing devices, wearable devices, digital media players, wearable devices, smart phones, cellular telephones, displays, printers, kitchen appliances, mobile computing devices, and so on.

Further, although FIGS. 1 and 7 both illustrate example electronic devices 100, 700 that include haptic displays 102, 702 that provide electrostatic haptic output, it is understood that these are examples. In various implementations, electronic devices using the techniques discussed herein may provide electrostatic output via any kind of surface. Examples of such surfaces include, but are not limited to, physical keys of a physical keyboard, touch screen surfaces, track pad surfaces, housing surfaces, watch crowns, and so on.

Additionally, other types of haptic output may be provided instead of and/or in addition to electrostatic haptics. Examples of such other haptics include, but are not limited to, one or more movements, temperatures, vibrations, and so on.

Moreover, although the above is illustrated and described in the context of providing electrostatic haptic output for virtual keys of a virtual keyboard, it is understood that this is an example. In various implementations, the techniques herein may be used for any kind of virtual or physical components, such as one or more buttons, dials, sliders, and so on. Various configurations are possible and contemplated.

FIG. 8 depicts relationships between components of an electronic device 800 that is operable to provide haptic output via an electrostatic haptic display, virtual keyboard device, or other electrostatic haptic output device. In some implementations, the electronic device 800 may be the electronic device 100 of FIG. 1, the electronic device 700 of FIG. 7, and so on.

The electronic device 800 may include one or more processing units 871 (or processors, controllers, and so on), one or more non-transitory storage media 872 (which may take the form of, but is not limited to, a magnetic storage medium; optical storage medium; magneto-optical storage medium; read only memory; random access memory; erasable programmable memory; flash memory; and so on), one or more static pattern electrostatic haptic electrodes 873 (such as one or more of those illustrated in FIGS. 2A-6), one or more sets of touch sensing circuitry 874 or other touch sensors or touch circuitry (such as capacitive touch sensing circuitry), one or more sets of display circuitry 875, one or more input/output components 876, one or more communication components 877, one or more power components 878 (which may include one or more power controllers, batteries, power supplies, voltage sources, and so on), and so on. In some examples, the processing unit 871 may execute instructions stored in the non-transitory storage media 872 to display a virtual keyboard including one or more virtual keys on a display and provide electrostatic haptic output for one or more of the virtual keys using one or more static pattern electrostatic haptic electrodes 873. Various configurations are possible and contemplated without departing from the scope of the present disclosure.

As described above and illustrated in the accompanying figures, the present disclosure relates to electronic devices that use static pattern electrostatic haptic electrodes to provide a variety of different haptic feedback. The static pattern electrostatic haptic electrodes may include conductive material that defines one or more voids and are disposed on an area of a surface under an insulator. The differing amounts of conductive material may cause electrostatic fields of differing strengths to interact with conductive objects, such as a user's finger, moving across the insulator. This may attract or repel the conductive object different amounts, resulting in different frictions between the conductive object and the insulator that may be perceptible as different textures. In this way, a static pattern electrostatic haptic electrode may be used to provide a variety of different haptic feedback depending on the varying surface area percentage occupied by the conductive material.

Further, in some implementations, the conductive material may include separate portions that may be provided different voltages. As the voltage provided to the conductive material affects the strength of the electrostatic field, separate conductive material portions with different voltages may increase the variety of haptic feedback that the static pattern electrostatic haptic electrodes may be capable of providing.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A haptic display, comprising:
a display device that is operable to display a virtual key within a virtual key area of the display device;
a static pattern electrostatic haptic electrode coupled to the display device in the virtual key area, the static pattern electrostatic haptic electrode comprising:
conductive material; and
at least one void defined within the conductive material;
an insulator covering the static pattern electrostatic haptic electrode; and
a controller operable to provide a voltage to the static pattern electrostatic haptic electrode.

2. The haptic display of claim 1, further comprising additional static pattern electrostatic haptic electrodes wherein:
the static pattern electrostatic haptic electrode and the additional static pattern electrostatic haptic electrodes are arranged in a keyboard configuration;
the display device is operable to display a virtual keyboard corresponding to the keyboard configuration; and
the controller is operable to provide the voltage to the static pattern electrostatic haptic electrode and voltages to the additional static pattern electrostatic haptic electrodes when the display device displays the virtual keyboard.

3. The haptic display of claim 1, wherein:
the conductive material comprises at least two separate portions; and
the controller is operable to provide at least two different voltages to the two separate portions.

4. The haptic display of claim 1, wherein the static pattern electrostatic haptic electrode includes less of the conductive material at a center of the virtual key area than at an edge of the virtual key area.

5. The haptic display of claim 1, wherein the static pattern electrostatic haptic electrode includes:
a first section with a first surface area percentage occupied by the conductive material; and
a second section with a second surface area percentage occupied by the conductive material that is less than the first surface area percentage.

6. The haptic display of claim 1, wherein the controller provides the voltage to the static pattern electrostatic haptic electrode when the display device is displaying the virtual key within the virtual key area of the display device.

7. The haptic display of claim 1, wherein:
the display device is operable to display the virtual key within the virtual key area of the display device or an additional virtual key within an additional virtual key area of the display device depending on an orientation of the haptic display;
the haptic display includes an additional static pattern electrostatic haptic electrode coupled to the display device in the additional virtual key area;
the controller provides the voltage to the static pattern electrostatic haptic electrode when the display device is displaying the virtual key within the virtual key area of the display device; and
the controller provides the voltage to the additional static pattern electrostatic haptic electrode when the display device is displaying the additional virtual key within the additional virtual key area of the display device.

8. The haptic display of claim 1, wherein the controller provides the voltage to the static pattern electrostatic haptic electrode via an inductive power transmitter.

9. An electrostatic haptic output device, comprising:
a surface;
conductive material disposed on an area of the surface;
voids surrounded by portions of the conductive material within the area of the surface such that a surface area percentage occupied by the conductive material is different in different sections of the area of the surface;
insulating material disposed on the conductive material; and
a controller operable to provide a voltage to the conductive material.

10. The electrostatic haptic output device of claim 9, wherein the conductive material comprises at least a first portion of the conductive material that surrounds a second portion of the conductive material.

11. The electrostatic haptic output device of claim 10, wherein the controller is operable to provide different voltages to the first portion of the conductive material and the second portion of the conductive material.

12. The electrostatic haptic output device of claim 9, further comprising touch sensing circuitry the controller is operable to use to determine a touch of a conductive object to the surface.

13. The electrostatic haptic output device of claim 12, wherein the controller is operable to provide the voltage to the conductive material and use the touch sensing circuitry to determine the touch of the conductive object to the surface at different times.

14. The electrostatic haptic output device of claim 12, wherein the conductive material comprises part of the touch sensing circuitry.

15. A virtual keyboard device, comprising:
a surface;
a static pattern electrostatic haptic electrode disposed on an area of the surface, the static pattern electrostatic haptic electrode defining voids on the area of the surface between contiguous portions of the static pattern electrostatic haptic electrode;
insulating material disposed on the static pattern electrostatic haptic electrode; and
a controller operable to apply a voltage to the static pattern electrostatic haptic electrode; wherein application of the voltage to the static pattern electrostatic haptic electrode produces a variable friction between a conductive object and the insulating material as the conductive object moves across the insulating material.

16. The virtual keyboard device of claim 15, wherein the friction between the conductive object and the insulating material decreases as the conductive object moves across the insulating material towards a center of the static pattern electrostatic haptic electrode.

17. The virtual keyboard device of claim 15, wherein the friction between the conductive object and the insulating material increases as the conductive object moves across the insulating material towards a center of the static pattern electrostatic haptic electrode.

18. The virtual keyboard device of claim 15, wherein the controller is operable to apply the voltage to the static pattern electrostatic haptic electrode to simulate a texture gradient change as the conductive object moves across the insulating material.

19. The virtual keyboard device of claim 15, wherein:
the surface is planar; and
the controller is operable to apply the voltage to the static pattern electrostatic haptic electrode to simulate that the surface is curved.

20. The virtual keyboard device of claim 15, wherein the surface comprises a keyboard key.
